(19) United States
(12) Patent Application Publication
(10) Pub. No.: US 2018/0338329 A1
(43) Pub. Date: Nov. 22, 2018

(54) VEHICLE WI-FI CONFIGURATION TO AN EXTERNAL WIRELESS ACCESS POINT

(71) Applicant: GM Global Technology Operations LLC, Detroit, MI (US)

(72) Inventors: John Sergakis, Bloomfield Hills, MI (US); Nadav Lavi, Ramat-Hasharon (IL); Lakshmi V. Thanayankizil, Rochester Hills, MI (US)

(21) Appl. No.: 15/601,482

(22) Filed: May 22, 2017

(51) Int. Cl. H04W 76/02; H04W 48/20; H04L 12/24

(52) U.S. Cl. CPC H04W 76/02; H04W 48/20; H04W 12/06; H04L 41/0886; H04L 41/0806

(57) ABSTRACT

A method of configuring a wireless connection between a vehicle and a non-vehicle wireless access point (WAP) includes receiving at a vehicle communications device data relating to at least one non-vehicle WAP, wherein the data includes configuration data for establishing a connection to the at least one non-vehicle WAP, and when the at least one non-vehicle WAP is identified as being a user-specific non-vehicle WAP, automatically configuring the vehicle communications device as a client device to the user-specific non-vehicle WAP and establishing the wireless connection to the non-vehicle WAP associated with the user-specific location using the configuration data.

### INTRODUCTION

The present application relates to vehicle communications and, more particularly, to configuring communications between a vehicle and an external wireless access point.

Many vehicle systems now include communication devices such as telematics units and/or infotainment units that allow for nearby devices to connect to remote networks. In this way, the communication devices are configured as server devices having one or more wireless access points (i.e., wireless hotspots) that allow one or more client devices to connect thereto. The wireless access points may then be connected to a remote network over, for example, the Internet via a cellular network (e.g., through a connection to a telematics unit included in the vehicle that includes cellular network capabilities).

Alternatively, the vehicle communication devices may connect to one or more wireless access points that are external to the vehicle. In this way, the vehicle communication devices are configured as client devices to the external wireless access points, which enables short range wireless communication therebetween.

It may be desirable to automate the configuration procedure for connecting the vehicle communication devices to certain external wireless access points.

### SUMMARY

According to one embodiment, there is provided a method of configuring a wireless connection between a vehicle and a non-vehicle wireless access point (WAP), wherein the method includes receiving at a vehicle communications device a list of non-vehicle WAPs, wherein the list includes configuration data for establishing a connection to each of the non-vehicle WAPs. The method further includes filtering the list to determine which of the non-vehicle WAPs is associated with a user-specific location, and configuring the vehicle communications device to establish a wireless connection to the non-vehicle WAP associated with the user-specific location using the configuration data. In this way, the vehicle communications device is configured as a client device to the non-vehicle WAP associated with the user-specific location. The configuration data may include a service set identifier (SSID) and security credentials for establishing the wireless connection to the non-vehicle WAP. When configured, the non-vehicle WAP associated with a user-specific location provides the vehicle communications device with access to remote networks through the non-vehicle WAP and a network access device. In one example, the list of non-vehicle WAPs is received at the vehicle from an application installed on a wireless device either directly, or via a remote facility.

The method may further include scanning for available non-vehicle WAPs using the vehicle communications device, and filtering the list of non-vehicle WAPs by comparing a signal strength for each of the available non-vehicle WAPs to a signal strength for each of the plurality of non-vehicle WAPs. In addition, filtering the list may include determining a location of the vehicle, comparing the location of the vehicle to the user-specific location, or determining a time-of-day.

According to another embodiment, there is provided a method of configuring a wireless connection between a vehicle and a non-vehicle WAP, wherein the method includes receiving at a vehicle communications device data that relates to at least one non-vehicle WAP, wherein the data includes configuration data for establishing a connection to the at least one non-vehicle WAP, and when the at least one non-vehicle WAP is identified as being a user-specific non-vehicle WAP, automatically configuring the vehicle communications device as a client device to the user-specific non-vehicle WAP and establishing the wireless connection to the non-vehicle WAP associated with the user-specific location using the configuration data. The configuration data may include a service set identifier (SSID) and security credentials for establishing the wireless connection to the non-vehicle WAP. In one example, the list of non-vehicle WAPs is received at the vehicle from an application installed on a wireless device either directly, or via a remote facility.

In one example, when the at least one non-vehicle WAP includes a plurality of non-vehicle WAPs, the method may further include prompting a user to select from the plurality of non-vehicle WAPs the user-specific non-vehicle WAP, configuring the vehicle communications device as a client device to the selected user-specific non-vehicle WAP using the configuration data, and establishing the wireless connection to the selected non-vehicle WAP associated with the user-specific location using the configuration data.

In another example, when the at least one non-vehicle WAP includes a plurality of non-vehicle WAPs, the method may further include filtering the plurality of non-vehicle WAPs to determine which is a user-specific non-vehicle WAP.

The method may further include detecting available wireless communication networks using the vehicle communications device, and filtering the plurality of non-vehicle WAPs by comparing a signal strength for each of the available wireless communication networks to a signal strength for each of the plurality of non-vehicle WAPs, determining a location of the vehicle, comparing the location of the vehicle to the user-specific location, and determining a time-of-day.

According to another embodiment, there is provided a vehicle communications system having a vehicle communications device configured to receive data relating to at least one non-vehicle WAP, wherein the data includes configuration data for establishing a connection to the at least one non-vehicle WAP, When the at least one non-vehicle WAP is identified as being a user-specific non-vehicle WAP, the communications device is configured as a client device to the user-specific non-vehicle WAP and the wireless connection is established to the non-vehicle WAP using the configuration data. When the at least one non-vehicle WAP includes a plurality of non-vehicle WAPs, a user is prompted to select from the plurality of non-vehicle WAPs the user-specific non-vehicle WAP. Alternatively, the plurality of non-vehicle WAPs is filtered to determine which is the user-specific non-vehicle WAP. In one example, the data relating to the at least one non-vehicle WAP is received at the vehicle from an application installed on a wireless device either directly, or via a remote facility.

### BRIEF DESCRIPTION OF THE DRAWINGS

One or more embodiments of the invention will hereinafter be described in conjunction with the appended drawings, wherein like designations denote like elements, and wherein:

FIG. 1 is a block diagram depicting an embodiment of a communications system that is capable of utilizing the method disclosed herein; and

FIG. 2 is a flowchart depicting an embodiment of a method of configuring a wireless connection between a vehicle and a non-vehicle wireless access point (WAP) using the system of FIG. 1.

### DETAILED DESCRIPTION

The system and method described below are directed to configuring wireless communications between a vehicle and an external, non-vehicle wireless access point (WAP). The system includes a vehicle communications device configured to receive configuration data relating to a user-specific non-vehicle WAP, which in one embodiment, is at the user's residence, but may also be at a different location associated with the user, such as a place of business. Upon receiving the configuration data relating to the user-specific non-vehicle WAP, the vehicle communications device automatically configures a wireless connection thereto using the configuration data, which includes a service set identifier (SSID) and security credentials associated with the user-specific non-vehicle WAP.

Alternatively, the vehicle communications device may be configured to receive a list of non-vehicle WAPs, wherein the list includes configuration data for establishing a connection to each of the non-vehicle WAPs. The list may also include filtering data used by the vehicle communications device to filter the list and to determine which of the non-vehicle WAPs in the list are associated with a user-specific location. In one implementation, the filtering process includes scanning for available wireless networks (i.e., available non-vehicle WAPs) and filtering the list by at least one of, or a combination of: comparing a signal strength for each of the available non-vehicle WAPs to a signal strength for each of the non-vehicle WAPs in the list, determining a location of the vehicle, comparing the location of the vehicle to the user-specific location, or determining a time-of-day. After identifying which of the non-vehicle WAPs in the list is associated with a user-specific location, the vehicle communications device automatically configures a wireless connection thereto using the configuration data.

In each of the embodiments set forth above, the configuration data relating to the user-specific non-vehicle WAP, and/or the list of non-vehicle WAPs, is sent to the vehicle communications device from an application installed on a wireless device either directly, or indirectly via a remote facility, which in one embodiment is associated with a remote back-end facility.

### Communications System—

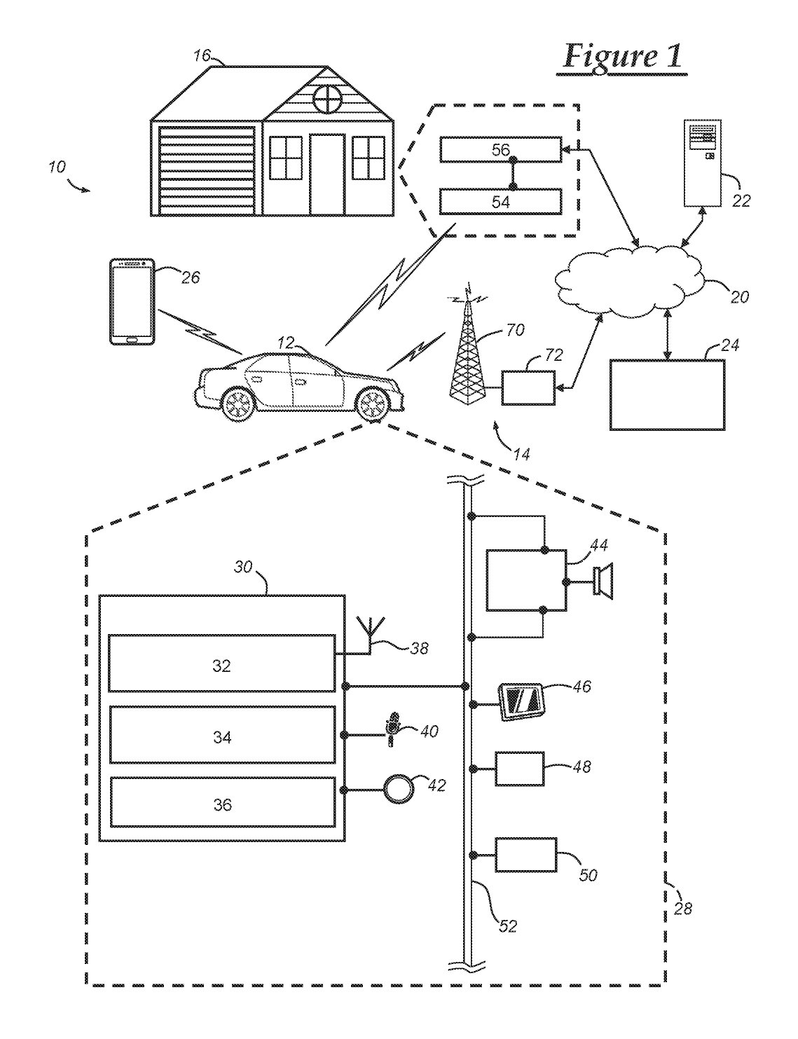

With reference to FIG. 1, there is shown an operating environment that comprises a mobile vehicle communications system 10 and that can be used to implement the methods disclosed herein. Communications system 10 generally includes a vehicle 12, one or more wireless carrier systems 14, a fixed location 16, a land communications network 20, a computer 22, a remote facility 24, and mobile device 26. It should be understood that the disclosed method can be used with any number of different systems and are not specifically limited to the operating environment shown here. Also, the architecture, construction, setup, and operation of the system 10 and its individual components are generally known in the art. Thus, the following paragraphs simply provide a brief overview of one such communications system 10; however, other systems not shown here could employ the disclosed methods as well.

Vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. Some of the vehicle electronics 28 are shown generally in FIG. 1 and include a vehicle communications device 30, a microphone 40, one or more pushbuttons or other control inputs 42, an audio system 44, a visual display 46, and a GPS module 48 as well as a number of other vehicle system modules (VSMs) 50. Some of these devices can be connected directly to the communications device 30 such as, for example, the microphone 40 and pushbutton(s) 42, whereas others are indirectly connected using one or more network connections, such as a communications bus 52. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

Wireless carrier system 14 may be any suitable cellular telephone system. Carrier system 14 is shown as including a plurality of cell towers 70 (only one shown) and one or more mobile switching centers (MSCs) 72; however, the carrier system 14 may include one or more of the following components (e.g., depending on the cellular technology): cellular towers, base transceiver stations, mobile switching centers, base station controllers, evolved nodes (e.g., eNodeBs), mobility management entities (MMEs), serving and PGN gateways, etc., as well as any other networking components required to connect wireless carrier system 14 with the land network 20 or to connect the wireless carrier system 14 with user equipment (UEs, e.g., which include telematics equipment in vehicle 12). Cellular system 14 can implement any suitable communications technology, including for example, analog technologies including for example GSM/GPRS technology, CDMA or CDMA2000 technology, LTE technology, etc. In general, wireless carrier systems 14, their components, the arrangement of their components, the interaction between the components, etc. is generally known in the art.

Apart from using wireless carrier system 14, a different wireless carrier system in the form of satellite communication can be used to provide uni-directional or bi-directional communication with the vehicle. This can be done using one or more communication satellites (not shown) and an uplink transmitting station (not shown). Uni-directional communication can be, for example, satellite radio services, wherein programming content (news, music, etc.) is received by the transmitting station, packaged for upload, and then sent to the satellite, which broadcasts the programming to subscribers. Bi-directional communication can be, for example, satellite telephony services using a satellite to relay telephone communications between the vehicle 12 and the uplink transmitting station. If used, this satellite telephony can be utilized either in addition to or in lieu of wireless carrier system 14.

The location 16 is depicted in FIG. 1 as a residential home, however, it should be appreciated that location 16 may be any location, such as a workplace or other user-specific location that includes a wireless access point 54 and/or a router 56. As used herein, a user-specific location is any location that is specific to a user of the vehicle. A non-vehicle wireless access point is a wireless access point (WAP), as defined above, which is not installed as part of the vehicle electronics 28. The non-vehicle WAP may be located in the vehicle, but not physically integrated into the vehicle electronics or it may be an external WAP located outside the vehicle, including a residential or commercial location, such as location 16. Thus, as used herein, a user-specific non-vehicle WAP is any non-vehicle WAP that is associated with a location specific to a user of the vehicle. Router 56 is a network access device and, as shown, may provide network connectivity via land network 20. A network access device is a hardware device that communicates with one or more remote networks using a router and/or a modem. For example, location 16 may include a modem (not shown) that is configured to transfer data between the router 56 and land network 20. In addition, while shown as separate components, WAP 54 and router 56 may also be integrated into a single device.

Land network 20 may be a conventional land-based telecommunications network that is connected to one or more landline telephones and connects wireless carrier system 14 to remote facility 24. For example, land network 20 may include a public switched telephone network (PSTN) such as that used to provide hardwired telephony, packet-switched data communications, and the Internet infrastructure. One or more segments of land network 20 could be implemented through the use of a standard wired network, a fiber or other optical network, a cable network, power lines, other wireless networks such as wireless local area networks (WLANs), or networks providing broadband wireless access (BWA), or any combination thereof. Furthermore, remote facility 24 need not be connected via land network 20, but could include wireless telephony equipment so that it can communicate directly with a wireless network, such as wireless carrier system 14.

Computer 22 can be one of a number of computers accessible via a private or public network such as the Internet. Computer 22 is remotely located with respect to the vehicle and is a part of a remote network, which is accessible by the vehicle via a WAP, remote access device, and land network 20. Each such computer 22 can be used for one or more purposes, such as a web server accessible by the vehicle via vehicle communications device 30 and wireless carrier 14. Other such accessible computers 22 can be, for example: a service center computer where diagnostic information and other vehicle data can be uploaded from the vehicle via the vehicle communications device 30; a client computer used by the vehicle owner or other subscriber for such purposes as accessing or receiving vehicle data or to setting up or configuring subscriber preferences or controlling vehicle functions; or a third party repository to or from which vehicle data or other information is provided, whether by communicating with the vehicle 12 or remote facility 24, or both. A computer 22 can also be used for providing Internet connectivity such as DNS services or as a network address server that uses DHCP or other suitable protocol to assign an IP address to the vehicle 12.

Remote facility 24 is designed to provide the vehicle electronics 28 with a number of different system back-end functions. The remote facility 24 may include one or more switches, servers, databases, live advisors, as well as an automated voice response system (VRS), all of which are known in the art. Remote facility 24 may include any or all of these various components and, preferably, each of the various components are coupled to one another via a wired or wireless local area network. Remote facility 24 may receive and transmit data via a modem connected to land network 20. A database at the remote facility can store account information such as subscriber authentication information, vehicle information, profile records, behavioral patterns, and other pertinent subscriber information (e.g., a location or address associated with a subscriber such as, but not limited to, a home, residence, or place of business). Data transmissions may also be conducted by wireless systems, such as 802.11x, GPRS, and the like. Although the illustrated embodiment has been described as it would be used in conjunction with a manned remote facility 24 using a live advisor, it will be appreciated that the remote facility can instead utilize a VRS as an automated advisor or, a combination of the VRS and the live advisor can be used.

Mobile device 26 is a non-vehicle wireless device, meaning that it is a device capable of wireless communications and not a part of vehicle 12 or vehicle electronics 28. For example, the device 26 may be a vehicle operator's or user's cellular telephone or other personal mobile device. The mobile device includes: hardware, software, and/or firmware enabling cellular telecommunications and/or short range wireless communication (SRWC), as well as other wireless device functions and applications. The hardware of mobile device 26 comprises a processor and memory for storing the software, firmware, etc. This memory may include volatile RAM or other temporary powered memory, as well as a non-transitory computer readable medium that stores some or all of the software needed to carry out the various external device functions discussed herein. The mobile device processor and software stored in the memory enable various software applications, which may be preinstalled or installed by the user (or manufacturer) (e.g., having a software application or graphical user interface (GUI)), and which may be used to carry out all or part of the method disclosed herein. The application may be configured to allow a vehicle user to communicate with vehicle 12 through various communication protocols, such as near field communication (NFC). The application may also allow a vehicle user to control various aspects or functions of the vehicle—e.g., among other things, allowing the user to remotely lock/unlock vehicle doors, turn the vehicle ignition on or off, check the vehicle tire pressures, fuel level, oil life, etc. The application may also be used to enable the user of device 26 to view information pertaining to the vehicle (e.g., the current location of the vehicle, whether the vehicle is locked or unlocked) and/or pertaining to an account associated with the user or vehicle. In addition, the application may also allow the user to connect with the remote facility 24 or call center advisors at any time. Mobile device 26 is shown as a smartphone having cellular telephone capabilities. In other embodiments, device 26 may be a tablet, laptop computer, or any other suitable device.

Referring again to vehicle 12, and more particularly to vehicle electronics 28, wireless communications device 30 is configured to communicate data via short range wireless communications (SRWC), and as shown in the exemplary embodiment of FIG. 1, includes a wireless access point 32, a processor 34, memory 36, and antenna 38. In many embodiments, the wireless communications device 30 may be specifically configured to carry out the method disclosed herein. Wireless communications device 30 may be a standalone module or may be incorporated or included as a part of one or more other vehicle system modules, such as a body control module, an infotainment module, a telematics module, a head unit, central stack module (CSM), and/or a gateway module. In some embodiments, the device 30 can be implemented as an OEM-installed (embedded) or aftermarket device that is installed in the vehicle.

Wireless communications device 30 can be configured to communicate wirelessly using one or more wireless discovery mechanisms. As used herein, a wireless discovery mechanism is specific software protocol and/or set of hardware component(s) that can be used to transmit and receive wireless communications. A wireless discovery mechanism may include short range wireless communications (SRWC) such as any of the IEEE 802.11 protocols, WiMAX™, Wi-Fi™, Wi-Fi Aware™, Neighbor Awareness Networking (NAN), ZigBee™, Wi-Fi Direct™, Bluetooth™, Bluetooth Low Energy™ (BLE), Bonjour™, or near field communication (NFC). The wireless access points 32 may be configured to operate according to one or more wireless discovery mechanisms. Further, each access point 32 may include a wireless chipset that enables one or more wireless discovery mechanisms.

For example, wireless access point 32 may include a Bluetooth™ chipset and/or a Wi-Fi™ chipset. In such an example, wireless access point 32 may enable Bluetooth™ BLE wireless communications, Wi-Fi™, and Wi-Fi Aware™ communications. Additionally, in some embodiments, the wireless communications device 30 may contain a cellular chipset thereby allowing the device to communicate via one or more cellular protocols. Moreover, the vehicle may include numerous wireless communications devices and, in some embodiments, each of the wireless communications devices may include different wireless chipsets.

In addition to acting as a wireless access point for devices to connect thereto (e.g., a server mode), wireless communications device 30 may carry out wireless communications with another wireless access point, such as non-vehicle wireless access point (WAP) 54 at location 16. In such an arrangement, WAP 54 may be connected to router 56 and provide device 30 a connection to the Internet or other remote network. Device 30 may be set to a station (i.e., server) or client mode and, thus, may then carry out wireless communications with WAP 54. As used herein, a station or client mode is an operating mode of a wireless communications device that enables the device to act as a station or client device thereby allowing the device to scan for and connect to host devices (e.g., wireless access points). More particularly, in the client mode, the client device permits another device (a server device) to control communication protocols, etc. The WAP 54, acting as a server device, may be set to a wireless access point mode, thus providing a hotspot for device 30 to connect to when operating in a station mode. A hotspot is an area where a wireless data connection may be established between a wireless device operating in a station or client mode and the device hosting the hotspot via a wireless access point. It should be appreciated that the protocol used in providing a hotspot is not limited to Wi-Fi™ and that any SRWC, such as those listed above, may be used.

The wireless communication device 30 may operate in both a station or client mode and a wireless access point mode at the same time through, for example, use of a dual band antenna. Alternatively, or additionally, the wireless communications device 30 may switch between a wireless access point mode and a station mode thereby enabling both modes of operation at the same time. This would enable wireless communications device 30 to communicate concurrently with a first wireless device (e.g., a mobile device or VSM) operating in the wireless access point mode and to communicate with WAP 54 operating in the station mode. This may enable the vehicle to throttle wireless communications between devices at or near the vehicle (e.g., VSMs 50) and remote servers or computers (e.g., remote facility 24, computers 22) through device 30.

The wireless communications device 30 may be used by the vehicle to determine whether certain wireless services are available. Additionally, wireless communications device 30 may be used to offer services to one or more wireless devices, such as mobile device 26. As used herein, a wireless service is a service that is offered by one or more wireless devices (the “servicing device”) and/or used by one or more wireless devices where the service is performed at least in part through wireless communications. Such services may be, for example, a printing service or an Internet connection service. In one embodiment, the WAP 54 may be the servicing device and, in other embodiments, mobile device 26 may be the servicing device and may offer a variety of different services. Additionally, in some embodiments, both mobile device 26, wireless communications device 30, and WAP 54 may operate with one another to provide services among one another. In yet another embodiment, a wireless device connected to WAP 54, such as mobile device 26, may be the servicing device and WAP 54 may be an intermediary device that operates to broadcast certain services offered by the servicing device. There may be any number of intermediary devices and/or servicing devices in any given system 10.

The vehicle 12 may select a wireless discovery mechanism based on a vehicle state, such as an operating vehicle state or an environmental state. After selecting the wireless discovery mechanism, the vehicle may then listen for wireless messages using the selected wireless discovery mechanism. In one embodiment, the vehicle listens for and receives beacon messages via its WAP 32 from a servicing device, such as WAP 54. The vehicle may then evaluate the received messages to determine whether a desired wireless service, such as an Internet connection, is available. If so, the vehicle can generate and send a reply message to the servicing device. The reply message may include vehicle information, such as a media access control (MAC) address of the wireless communications device 30 or a vehicle identification number (VIN). The servicing device and the vehicle can then carry out subsequent correspondence to establish a secure connection, as described in detail below with respect to the disclosed method.

In some embodiments, the type of wireless connection that is to be established can be based on the type of service that is being utilized. For example, a printing service may require the communication of low amounts of messages and, thus, BLE may be sufficient. In another example, a large vehicle OTA update may be downloaded from a remote server, such as computer 22 or a server at remote facility 24, and, thus, a Wi-Fi™ connection may be more desirable. Additionally or alternatively, the type of wireless connection can be based on the vehicle state.

Also, wireless communications device 30 may be in communication with one or more remote networks via packet-switched data communication. This packet-switched data communication may be carried out through use of an non-vehicle wireless access point that is connected to a land network via a router or modem, such as WAP 54 and router 56 described above. When used for packet-switched data communication such as TCP/IP, the communications device 30 can be configured with a static IP address or can be set up to automatically receive an assigned IP address from another device on the network such as a router or from a network address server.

Packet-switched data communications may also be carried out via use of a cellular network that may be accessible by the device 30 via, for example, a telematics unit included in the vehicle. In one embodiment, the communications device 30 may also include a cellular chipset or be communicatively coupled to a device comprising a cellular chipset such as a telematics unit. In either event, communications device 30 may, via a cellular chipset, communicate data over wireless carrier system 14. In such an embodiment, radio transmissions may be used to establish a communications channel, such as a voice channel and/or a data channel, with wireless carrier system 14 so that voice and/or data transmissions can be sent and received over the channel. Data can be sent either via a data connection, such as via packet data transmission over a data channel, or via a voice channel using techniques known in the art. For combined services that involve both voice communication and data communication, the system can utilize a single call over a voice channel and switch as needed between voice and data transmission over the voice channel, and this can be done using techniques known to those skilled in the art.

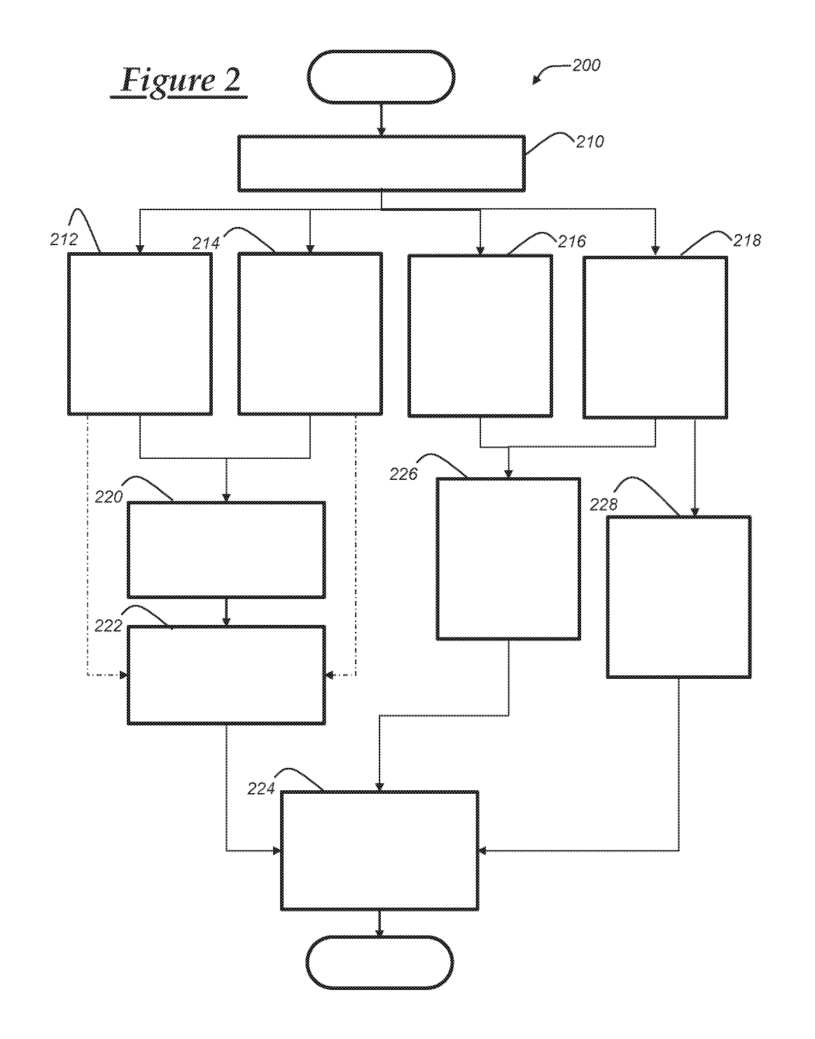

Processor 36 can be any type of device capable of processing electronic instructions including microprocessors, microcontrollers, host processors, controllers, vehicle communication processors, and application specific integrated circuits (ASICs). It can be a dedicated processor used only for communications device 30 or can be shared with other vehicle systems. Processor 36 executes various types of digitally-stored instructions, such as software or firmware programs stored in memory 38, which enable the device 30 to provide a wide variety of services. For instance, processor 36 can execute programs or process data to carry out at least a part of the method discussed herein. In one embodiment, device 30 includes an application that enables the method described below in FIG. 2. Memory 38 may include RAM, other temporary powered memory, any non-transitory computer-readable medium (e.g., EEPROM), or any other electronic computer medium that stores some or all of the software needed to carry out the various external device functions discussed herein.

Global position system (GPS) module 48 receives radio signals from a constellation of GPS satellites (not shown). From these signals, the module 48 can determine vehicle position which may enable the vehicle to determine whether it is at a known location, such as home or workplace 16. Moreover, GPS module 48 can provide this location data to wireless communications device 30, which can then use this data to identify known locations, such as a vehicle operator's home or workplace. Additionally, GPS module 48 may be used to provide navigation and other position-related services to the vehicle operator. Navigation information can be presented on the display 46 (or other display within the vehicle) or can be presented verbally such as is done when supplying turn-by-turn navigation. The navigation services can be provided using a dedicated in-vehicle navigation module (which can be part of GPS module 48), or some or all navigation services can be done via a telematics unit installed in the vehicle, wherein the position information is sent to a remote location for purposes of providing the vehicle with navigation maps, map annotations (points of interest, restaurants, etc.), route calculations, and the like. The position information can be supplied to remote facility 24 or other remote computer system, such as computer 22, for other purposes, such as fleet management. Also, new or updated map data can be downloaded to the GPS module 48 from the remote facility 24 via a vehicle telematics unit.

The vehicle system modules (VSMs) 50 are electronic hardware components that are located throughout the vehicle and typically receive input from one or more sensors and use the sensed input to perform diagnostic, monitoring, control, reporting and/or other functions. Each of the VSMs 50 is preferably connected by communications bus 52 to the other VSMs, such as the vehicle communications device 30, and can be programmed to run vehicle system and subsystem diagnostic tests. As examples, one VSM 50 can be an engine control module (ECM) that controls various aspects of engine operation such as fuel ignition and ignition timing, another VSM 50 can be a powertrain control module that regulates operation of one or more components of the vehicle powertrain, and another VSM 50 can be a body control module that governs various electrical components located throughout the vehicle, like the vehicle's power door locks and headlights. As is appreciated by those skilled in the art, the above-mentioned VSMs are only examples of some of the modules that may be used in vehicle 12, as numerous others are also possible.

Furthermore, it should be understood that at least some of the aforementioned modules could be implemented in the form of software instructions saved internal or external to vehicle communications device 30, they could be hardware components located internal or external to vehicle communications device 30, or they could be integrated and/or shared with each other or with other systems located throughout the vehicle, to cite but a few possibilities. In the event that the modules are implemented as VSMs 50 located external to vehicle communications device 30, they could utilize vehicle bus 52 to exchange data and commands with the vehicle communications device 30.

Vehicle electronics 28 also includes a number of vehicle user interfaces that provide vehicle occupants with a means of providing and/or receiving information, including microphone 40, pushbutton(s) 42, audio system 44, and visual display 46. As used herein, the term “vehicle user interface” broadly includes any suitable form of electronic device, including both hardware and software components, which is located on the vehicle and enables a vehicle user to communicate with or through a component of the vehicle. Audio system 44 provides audio output to a vehicle occupant and can be a dedicated, stand-alone system or part of the primary vehicle audio system. According to the particular embodiment shown here, audio system 44 is operatively coupled to both vehicle bus 52 and an entertainment bus (not shown) and can provide AM, FM and satellite radio, CD, DVD and other multimedia functionality. This functionality can be provided in conjunction with or independent of the infotainment module described above. Visual display or touch screen 46 is preferably a graphics display, such as a touch screen on the instrument panel or a heads-up display reflected off of the windshield, and can be used to provide a multitude of input and output functions. Microphone 40 provides audio input to the wireless communications device 30 to enable the driver or other occupant to provide voice commands and/or carry out hands-free calling via the wireless carrier system 14. For this purpose, it can be connected to an on-board automated voice processing unit utilizing human-machine interface (HMI) technology known in the art. The pushbutton(s) 42 allow manual user input into the communication device 30 to provide other data, response, or control input. Various other vehicle user interfaces can also be utilized, as the interfaces of FIG. 1 are only an example of one particular implementation.

It should also be appreciated that vehicle electronics 28 shown in FIG. 1 are only for purposes of illustration, as the actual arrangement or configuration of components, devices, modules, and/or systems could vary substantially from that shown here and it is not limited to any particular embodiment. For instance, the vehicle communications device 30, and/or the other vehicle modules may be stand-alone items or they may be combined or integrated with other components, devices, modules and/or systems in the vehicle. Therefore, it should be appreciated that this is but one embodiment of the possible system, as the system could be provided according to myriad configurations and arrangements.

Method—

Turning now to FIG. 2, there is provided an embodiment 200 of a method of configuring a wireless connection between a vehicle and a non-vehicle wireless access point (WAP) using the system described in FIG. 1. The disclosed method may be triggered according to a variety of circumstances, including, but not limited to: when the application is installed onto the mobile device 26 or periodically thereafter initiated by the application; when the vehicle communications device 30 detects that a hotspot (e.g., WAP 54) for the user-specific location 16 is not configured; or when the vehicle communications device 30 is unable to find and/or connect to a WAP 54 at the user-specific location 16.

The method begins with step 210 wherein an application installed on the wireless device 26 generates a list of available or previously configured non-vehicle WAPs. The list may be generated, for example, in response to the mobile device 26 performing a scan for available networks. Thereafter, the method may proceed according to one of four process paths via steps 212, 214, 216, or 218, each of which is discussed in detail below.

The first process path begins at step 212, wherein the application installed on the wireless device 26 prompts a user to select from the list of available or previously configured non-vehicle WAPs, a user-specific non-vehicle WAP, such as WAP 54, that is associated with a location specific to the vehicle user. In one example, the location of the user-specific non-vehicle WAP may be the user's home or residence. Once selected, at step 220 the application on the wireless device 26 is configured to transmit configuration data relating to the selected user-specific non-vehicle WAP to a remote facility 24. The configuration data may include, but is not limited to, a service set identifier (SSID) and security credentials associated with the non-vehicle WAPs. An SSID is a sequence of 0-32 octets used to identify a wireless local area network and is intended to be unique for a particular area. An SSID is often referred to as a “network name.” The security credentials provide access to the non-vehicle WAPs and include, for example, but without limitation, a security key (e.g., private, shared, etc.) a wired equivalent privacy (WEP) key, WiFi protected address (e.g., WPA, WPA2, etc.), username, or password. The configuration data may also include data relating to the received signal strength of the non-vehicle WAP.

At step 222, the remote facility 24 transmits the configuration data relating to the selected user-specific non-vehicle WAP to the vehicle 12, and more specifically, to vehicle communications device 30. As an alternative to step 220, the application on the wireless device 26 may transmit the configuration data relating to the selected user-specific non-vehicle WAP directly to the vehicle 12 rather than through the remote facility 24. In addition, the selected user-specific non-vehicle WAP 54 may be transmitted directly to the vehicle 12 from the wireless device 26 using tap-to-configure via NFC.

At step 224, a wireless connection is automatically configured between the vehicle 12 and the selected user-specific non-vehicle WAP 54 using the configuration data, which may include security credentials for accessing WAP 54. Specifically, in one exemplary implementation, using the configuration data, a short range wireless communication is established between the vehicle communications device 30 and the selected user-specific non-vehicle WAP 54. In this way, the vehicle communications device 30 is configured as a client device to the non-vehicle WAP 54 associated with the user-specific location. As such, the non-vehicle WAP 54 provides the vehicle communications device 30 with access to remote networks through router 56.

The second process path begins at step 214, wherein the application installed on the wireless device 26 filters the list of available or previously configured non-vehicle WAPs to automatically determine which of the WAPs is associated with a location specific to the vehicle user. In one implementation, the filtering process includes, but is not limited to, evaluating the signal strength for each of the available non-vehicle WAPs. After determining the user-specific non-vehicle WAP, such as WAP 54, that is associated with a location specific to the vehicle user, the method proceeds to step 220 and step 222 as set forth above, wherein the application transmits configuration data relating to the selected user-specific non-vehicle WAP 54 to the remote facility 24, which then transmits the configuration data relating to the selected user-specific non-vehicle WAP 54 to the vehicle 12, and more specifically, to vehicle communications device 30. Alternatively, the application on the wireless device 26 may transmit the configuration data relating to the selected user-specific non-vehicle WAP directly to the vehicle 12 rather than through the remote facility 24. Like the first process path, the method then proceeds to step 224, wherein a wireless connection is automatically configured between the vehicle 12 and the selected user-specific non-vehicle WAP 54 using the configuration data, which may include security credentials for accessing WAP 54.

The third process path begins at step 216, wherein the list of available or previously configured non-vehicle WAPs generated at step 210 is sent to the remote facility 24. The list may include data providing information relating to each of the non-vehicle WAPs in the list. The data may include, without limitation, configuration data such as the SSID and security credentials associated with the non-vehicle WAPs, and filtering data such as RSSI data for each of the non-vehicle WAPs and user location data, such as a residential address, etc. At step 226, the list of available or previously configured non-vehicle WAPs is filtered at the remote facility to determine which of the WAPs is associated with a location specific to the vehicle user. Alternatively, the list may be filtered to reduce that number of non-vehicle WAPs, and consequently, the amount of data to be transmitted from the remote facility 24. In one implementation, the filtering process includes, but is not limited to, evaluating: a signal strength for each of the available non-vehicle WAPs; the location of the vehicle; the location of the vehicle in relation to the user-specific location; or the time-of-day. In one example, as a result of the filtering process, the list may be reduced to include only networks that have a received or relative signal strength indicator (RSSI) that is equal to or above a particular threshold. This indicates that the non-vehicle WAPs are active for a particular location.

After determining the user-specific non-vehicle WAP, such as WAP 54, that is associated with a location specific to the vehicle user (or a reduced/filtered list), the method proceeds to step 222 as set forth above, wherein the remote facility 24 transmits the configuration data relating to the selected user-specific non-vehicle WAP 54 to the vehicle 12, and more specifically, to vehicle communications device 30. When the transmission includes a reduced or filtered list rather than a location specific WAP, the data transmitted may also include filtering data such as, but not limited to, signal strength data for each of the WAPs in the list. This data may be utilized in subsequent filtering processes. Like the first and second process paths, the method then proceeds to step 224, wherein a wireless connection is automatically configured between the vehicle 12 and the selected user-specific non-vehicle WAP 54 using the configuration data, which may include security credentials for accessing WAP 54.

The fourth process path begins at step 218, wherein the list of available or previously configured non-vehicle WAPs generated at step 210 is sent to the vehicle 12. The list may include data providing information relating to each of the non-vehicle WAPs in the list. The data may include, without limitation, configuration data such as the SSID and security credentials associated with the non-vehicle WAPs, and filtering data such as RSSI data and user location data. At step 228, the list of available or previously configured non-vehicle WAPs is filtered at the vehicle to determine which of the WAPs is associated with a location specific to the vehicle user. In one implementation, the filtering process includes scanning for available wireless networks (i.e., available non-vehicle WAPs) and filtering the list by at least one of, or a combination of: comparing a signal strength for each of the available non-vehicle WAPs to a signal strength for each of the non-vehicle WAPs in the list, determining a location of the vehicle, comparing the location of the vehicle to the user-specific location, or determining a time-of-day. After identifying which of the non-vehicle WAPs in the list is associated with a user-specific location, such as WAP 54, the method once again proceeds to step 224, wherein the vehicle communications device 30 automatically configures a wireless connection to the selected user-specific non-vehicle WAP 54 using the configuration data. As an alternative to the filtering process in step 228, the vehicle at step 230 may display the list of available or previously configured non-vehicle WAPs and prompt the user to select therefrom a user-specific non-vehicle WAP, such as WAP 54, that is associated with a specific location, such as a residence or place of business. Once selected, the method proceeds to step 224, wherein a wireless connection is automatically configured between the vehicle 12 and the selected user-specific non-vehicle WAP 54 using the configuration data. The non-vehicle WAP 54 may thereafter be used as a hot spot for Internet and other data communication to and from the vehicle.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. A method of configuring a wireless connection between a vehicle and a non-vehicle wireless access point (WAP), the method comprising:
receiving at a vehicle communications device a list of non-vehicle WAPs, wherein the list includes configuration data for establishing a connection to each of the non-vehicle WAPs;
filtering the list of non-vehicle WAPs to determine which of the non-vehicle WAPs is associated with a user-specific location; and
configuring the vehicle communications device to establish a wireless connection to the non-vehicle WAP associated with the user-specific location using the configuration data.

2. The method of claim 1, wherein the configuration data includes a service set identifier (SSID) and security credentials for establishing the wireless connection to the non-vehicle WAP.

3. The method of claim 1, further including providing the vehicle communications device with access to remote networks using the non-vehicle WAP associated with a user-specific location and a network access device.

5. The method of claim 1, wherein the list of non-vehicle WAPs is received at the vehicle via an application installed on a wireless device.

6. The method of claim 1, wherein the list of non-vehicle WAPs is received at the vehicle from an application installed on a wireless device via a remote facility.

7. The method of claim 1, further including scanning for available non-vehicle WAPs using the vehicle communications device, and wherein filtering the list of non-vehicle WAPs includes at least one of: comparing a signal strength for each of the available non-vehicle WAPs to a signal strength for each of the plurality of non-vehicle WAPs, determining a location of the vehicle, comparing the location of the vehicle to the user-specific location, or determining a time-of-day.

8. The method of claim 1, further including configuring the vehicle communications device as a client device to the non-vehicle WAP associated with the user-specific location.

9. A method of configuring a wireless connection between a vehicle and a non-vehicle wireless access point (WAP), the method comprising:
receiving at a vehicle communications device data relating to at least one non-vehicle WAP, wherein the data includes configuration data for establishing a connection to the at least one non-vehicle WAP; and
when the at least one non-vehicle WAP is identified as being a user-specific non-vehicle WAP, automatically configuring the vehicle communications device as a client device to the user-specific non-vehicle WAP and establishing the wireless connection to the non-vehicle WAP associated with the user-specific location using the configuration data.

10. The method of claim 9, further including:
when the at least one non-vehicle WAP includes a plurality of non-vehicle WAPs, prompting a user to select from the plurality of non-vehicle WAPs the user-specific non-vehicle WAP;
configuring the vehicle communications device as a client device to the selected user-specific non-vehicle WAP using the configuration data; and
establishing the wireless connection to the selected non-vehicle WAP associated with the user-specific location using the configuration data.

11. The method of claim 9, further including:
when the at least one non-vehicle WAP includes a plurality of non-vehicle WAPs, filtering the plurality of non-vehicle WAPs to determine which is a user-specific non-vehicle WAP.

12. The method of claim 11, further including detecting available wireless communication networks using the vehicle communications device, and wherein filtering the plurality of non-vehicle WAPs includes comparing a signal strength for each of the available wireless communication networks to a signal strength for each of the plurality of non-vehicle WAPs.

13. The method of claim 11, wherein filtering the plurality of non-vehicle WAPs includes:
determining a location of the vehicle; and
comparing the location of the vehicle to the user-specific location.

14. The method of claim 11, wherein filtering the plurality of non-vehicle WAPs includes determining a time-of-day.

15. The method of claim 9, wherein the configuration data includes a service set identifier (SSID) and security credentials for establishing the wireless connection with the at least one non-vehicle WAP.

16. The method of claim 9, wherein the data relating to the at least one non-vehicle WAP is received at the vehicle via an application installed on a wireless device.

17. The method of claim 9, wherein the data relating to the at least one non-vehicle WAP is received at the vehicle from an application installed on a wireless device via a remote server.

18. A vehicle communications system, comprising:
a vehicle communications device configured to:
receive data relating to at least one non-vehicle WAP, wherein the data includes configuration data for establishing a connection to the at least one non-vehicle WAP;
when the at least one non-vehicle WAP is identified as being a user-specific non-vehicle WAP, automatically configuring the vehicle communications device as a client device to the user-specific non-vehicle WAP and establishing the wireless connection to the non-vehicle WAP associated with the user-specific location using the configuration data; and
when the at least one non-vehicle WAP includes a plurality of non-vehicle WAPs, prompting a user to select from the plurality of non-vehicle WAPs the user-specific non-vehicle WAP, or filtering the plurality of non-vehicle WAPs to determine which is the user-specific non-vehicle WAP.

19. The system of claim 18, wherein the data relating to the at least one non-vehicle WAP is received at the vehicle from an application installed on a wireless device.

20. The system of claim 18, wherein the data relating to the at least one non-vehicle WAP is received at the vehicle from an application installed on a wireless device via a remote server.
